(19) United States
(12) Patent Application Publication
(10) Pub. No.: US 2007/0174512 A1
(43) Pub. Date: Jul. 26, 2007

(54) Method for driving I/O device of storage element

(75) Inventors: Hsiang-Hua Chao, Taipei (TW); Yu-Hung Liu, Tiu-Liu City (TW); Yi-Chen Ho, Taipei (TW); Yi-Chin Huang, Taipie (TW); Yu-Shen Liu, Taichung (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: C-Media Electronics Inc.

(21) Appl. No.: 11/289,669

(22) Filed: Nov. 29, 2005

(51) Int. Cl. G06F 5/00; G06F 3/00

(52) U.S. Cl. 710/52

(57) ABSTRACT

The conventional I/O devices of a storage element, such as memory card, have a built-in microprocessor control unit (MCU) for executing the I/O commands. The demand of MCU increases the cost. Besides, the capacity of the storage element supported by the device is depend on the firmware inside the MCU. Since the updating of firmware is a tough job, the supportability is lack of elasticity. This invention discloses a method for driving the I/O device of storage element that strengthens the device driver to get rid of the MCU. The capacity supported hence can be raised by merely updating the device driver.

### FIELD OF THE INVENTION

The present invention relates to a method for driving I/O (input/output) devices of a storage element, more particularly relates to a method for driving I/O devices of storage element without built-in microprocessor control unit (MCU).

### BACKGROUND OF THE INVENTION

The conventional I/O (input/output) devices of a storage element, such as memory card reader, have a built-in microprocessor control unit (MCU). The MCU is with some microinstructions, and the communication between the conventional I/O devices of storage element and a computer is controlled by calling the microinstructions. The main function of the MCU is to compile USB instructions, in order to make the I/O devices of the storage element performing some specific functions, such as reading, writing and reporting the related information of the storage element. Besides, some storage elements are lack of a built-in MCU, such as Smart Media card, eXtreme Digital card and Memory Stick; the MCU of the I/O device builds a physical to logical translation table (PLT table) according to the capacity of the storage elements and the MCU also maintains the PLT table.

Generally, the method for driving the conventional I/O devices of the storage element is to deliver SCSI (small computer system interface) instructions to the storage element by the bus driver. Then the built-in MCU of the storage element calls specific microinstructions by demand, in order to perform the requested jobs. The condition of the method is that the I/O device must have SCSI instructions compatible MCU, and it results that the cost of the I/O devices is extremely high. In this highly competition environment of the electrical device industrial, these kinds of products will lose their attractions to the public, and the manufacturer needs to find more economical methods for reading/writing the storage elements.

Moreover, the improvement of the technical industrial is in a tremendous progress, and the capacities of the storage elements, such as memory cards or micro drives, also grow rapidly. The conventional I/O devices of storage element are under the limitation of the firmware inside the MCU, they can not fully support newer storage elements which have larger capacities. That causes users have to consider the compatibility of existed I/O devices of storage elements before buying a larger storage element. If the capacity of new storage element can not be fully supported by existed I/O device, the only choice of the user is to purchase a new I/O device that can support the new storage element, or purchase a storage element with smaller capacity in order to meet the compatibility of existed I/O device. Supposing that the firmware inside the MCU of the I/O device can be upgraded, and then the I/O device will become more flexible. However, the failure rates and the risks of firmware upgrading are considerably high, so most vendors do not encourage users to upgrade their firmware, and even more many vendors do not provide relating services.

### SUMMARY OF THE INVENTION

According to aforementioned problems, one purpose of present invention is to provide a method for driving I/O (input/output) devices of a storage element. Pre-compiling the SCSI (small computer system interface) instructions by I/O device driver in computer, and finishes the task by the I/O device which is without a built-in microprocessor control unit (MCU).

Another purpose of present invention is to provide a method for driving I/O devices of the storage element. The method starts at using an I/O device driver in computer to build up a physical to logical translation table (PLT table) for the I/O device which is lack of a built-in MCU. Then the computer can retrieve the capacity information of the storage element, and the compatibility of various capacity of storage element becomes more flexible.

In view of foregoing purposes, the present invention disclosures a method for driving I/O devices of storage element. The steps of the method comprise: sending an I/O request from a user; building hardware independent SCSI instructions based on the I/O request by a storage class driver; executing the hardware independent SCSI instructions by a storage port driver and transferring the hardware independent SCSI instructions into hardware dependent instructions; delivering the hardware dependent instructions by a bus driver to the I/O device of storage element; and executing tasks according to the hardware dependent instructions by the I/O device of storage element.

In accordance with another purpose of the present invention, the present invention disclosures a method for driving a card reader, which comprises: performing an I/O request by a software application; building an I/O request by a storage class driver packet according to the I/O request, wherein the I/O request packet further comprises SCSI request blocks and command descriptor blocks; transferring the SCSI request blocks of the I/O request packet by a card reader driver into acceptable instruction formats of the card reader; delivering the acceptable instruction formats of the card reader by a USB (universal serial bus) driver in a form of frame to the card reader; and the card reader executing task according to data inside the frame.

### BRIEF DESCRIPTION OF THE DRAWINGS

The present invention will be readily understood by the following detailed description in conjunction with the accompanying drawings.

FIG. 1 is a block diagram which illustrates instruction passing structure.

FIG. 2 is a flow chart which illustrates process of instruction processing.

FIG. 3 is a flow chart which illustrates process of instruction dispatching.

FIG. 4 is a flow chart which illustrates process of retrieving capacity information.

FIG. 5 is a flow chart which illustrates process of reading data.

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

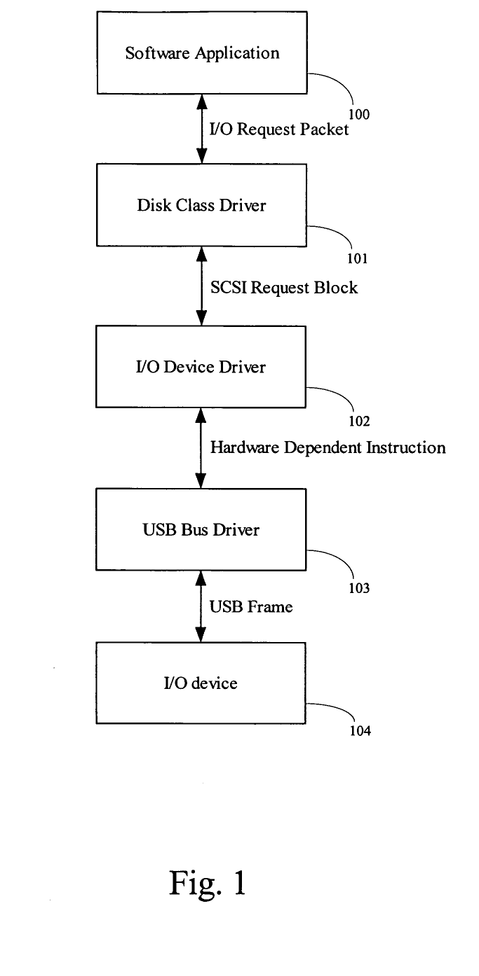

Referring to FIG. 1, which is a block diagram illustrating instruction passing structure. In one of the preferred embodiment, a user may use software application 100 for sending a request to I/O (input/output) devices of a storage element 104, the request is typically delivered in a form of I/O request packet (IRP). Subsequently, the IRP is delivered to a disk class driver 101, and after receiving the IRP, the disk class driver 101 builds a SCSI (small computer system interface) request block (SRB) by reference to data of the IRP. Moreover, the IRP further comprises a command descriptor block (CDB), then the I/O devices of storage element 104 can be used as a SCSI device in order to delivery SRBs which includes CDBs.

Aforementioned SRBs are then delivered to a device driver 102 of I/O devices of the storage element for further processing, and foregoing disk class driver 101 is a storage class driver. Because the I/O device of the preferred embodiment is not a SCSI device and received SRBs for device driver 102 are hardware independent SCSI instructions, the device driver 102 of I/O device of the storage element must execute and transfer them into hardware dependent instructions. Furthermore, the hardware dependent instructions will be passed to a bus driver 103, and it will be delivered to the I/O device of the storage element 104 through specific bus, subsequently. In accordance with the preferred embodiment, the specific bus is USB (universal serial bus), but other buses are also suitable in other embodiments. There is an asynchronous communication between the USB and the I/O device in a form of frame.

The direction of the data connection in FIG. 1 can be reversal, so the arrowheads between each block are all bi-directional. The I/O device of the preferred embodiment can delivery related information of the storage elements, such as capacity, data and status etc. . . . , to the user's software application in a reversal manner, in order to reach the purpose of bi-directional communication.

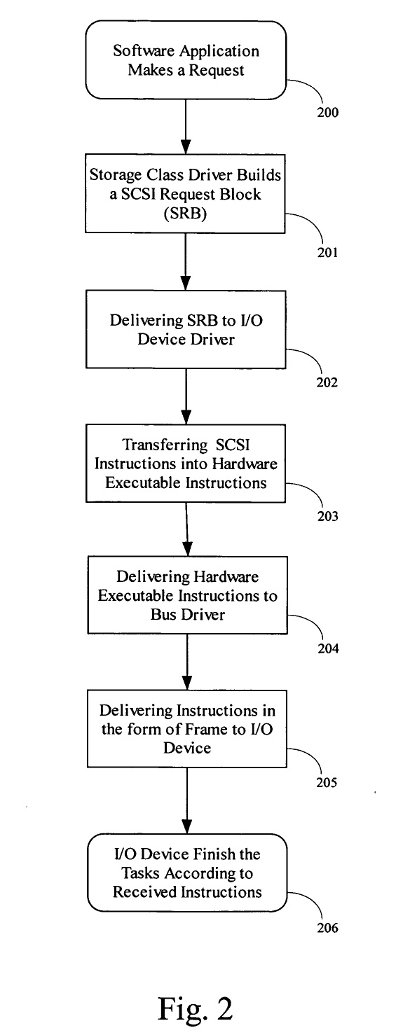

Referring to FIG. 2, which is a flow chart that illustrates process of instruction processing. In this embodiment, a software application makes a request 200 to I/O device, and a storage class driver builds SRBs 201 which includes CDBs according to the request in 200. Then the SRBs in step 201 are delivered to the I/O device driver in 202; base on the received SRBs are hardware independent SCSI instructions, SRBs need to be transferred into hardware executable instructions in step 203. The hardware executable instructions in 203 are next delivered to a bus driver 204, and the bus could be a USB in the embodiment. At that time, the hardware executable instructions 203 are delivered to the I/O device in 205 in a form of frame, and the I/O device 205 will perform the task in step 206 in reference to the hardware executable instructions 203.

Because the I/O device in the embodiment is lack of a built-in MCU, the SCSI instructions can not directly call the microinstructions inside firmware of the MCU, so the SCSI instructions need to be compiled into hardware executable instructions in the phase of device driver.

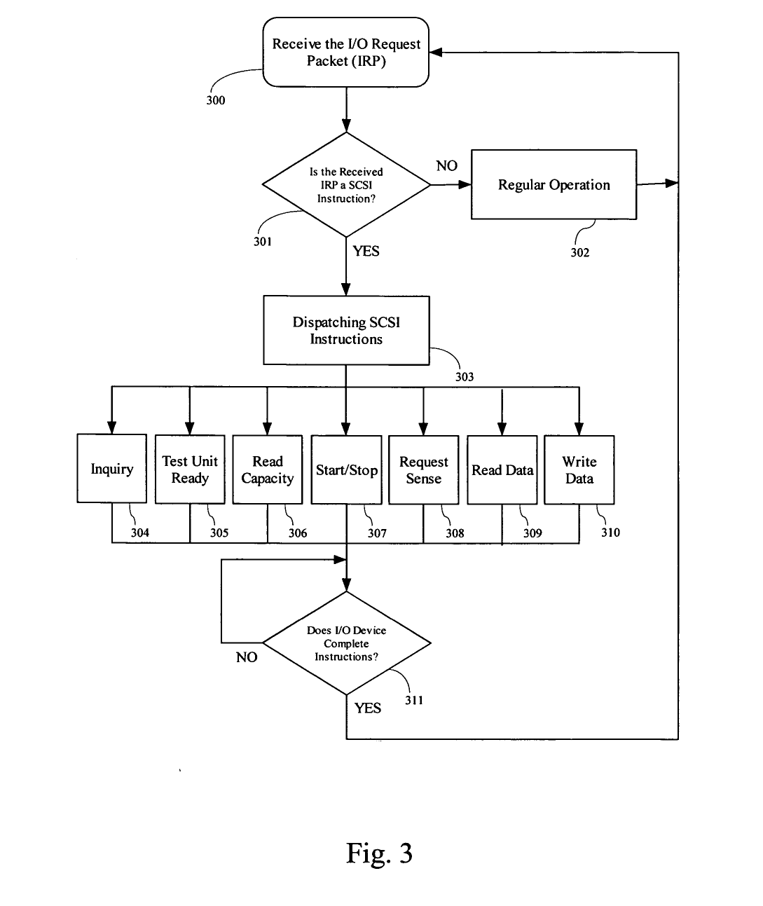

Referring to FIG. 3, which is a flow chart that illustrates process of instruction dispatching. It disclosures what process of I/O device driver processing the SCSI instructions in present invention is. First, after receiving the IRP from system or user 300, the I/O device driver analyzes whether the received IRP is a SCSI instruction or not 301. If the received IRP is not a SCSI instruction, whole process moves to the regular operation 302. Otherwise, after confirming the received IRP is a SCSI instruction, the SCSI instruction is mapped/dispatched to relative hardware dependent instruction in step 303. All of the hardware dependent instructions include Inquiry 304, Test Unit Ready 305, Read Capacity 306, Start/Stop 307, Request Sense 308, Read Data 309 and Write Data 310. After the mapping/dispatching process, the I/O device driver verifies whether the IRP is end or not 311. If there still are some unprocessed data, the process goes to step 300 in order to finish the mapping/dispatching processing. However, assumption that the IRP is not ended, and then the I/O device driver goes into a waiting stage, after the I/O device driver successfully receives the notification which is sent from the bus driver, recites all tasks inside the IRP being done, and then whole process goes back to disk class driver layer.

Furthermore, the Inquiry 304 is used to send the information of the storage element back to the system, and the Test Unit Ready 305 is utilized to verify whether the storage element has been initialized or not. If the storage element has not been initialized, the I/O device driver initializes the storage element and returns the update information of the storage element. The Start/Stop 307 is used to notify the I/O device driver whether the storage element is ready or not. Besides, the Request Sense 308 is introduced for sending error codes in order to verify error's types; furthermore, the Read Capacity 306, the Read Data 309 and the Write Data 310 will be described in detailed in subsequent description.

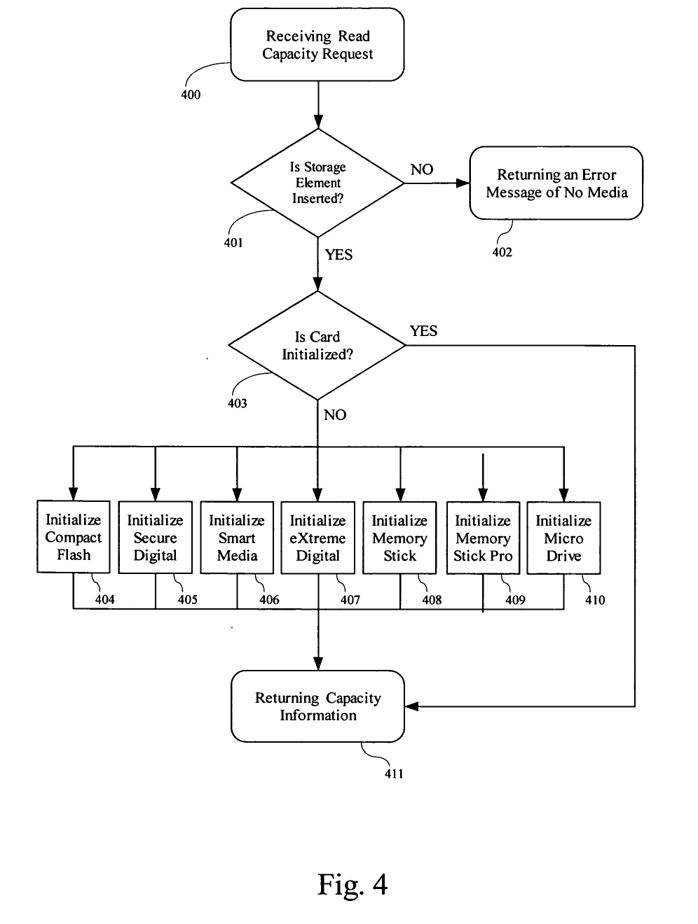

Referring to FIG. 4, which is a flow chart that illustrates process of retrieving capacity information by executing the SCSI instruction Read Capacity 306. After the system receives a request for capacity information 400, the I/O device checks the availability of the storage element in step 401. If there is no storage element inserted in the I/O device, the system returns an error message indicating that there is no media inserted therein in step 402. Otherwise, if there is a storage element that is inserted in the I/O device, and the system will check whether or not the storage element has been initialized. The system returns the capacity information of the storage element in step 411. However, if the inserted storage element has not been initialized, the system starts the step of initializing process according to the media type of the storage element indicated by 404-410. In preferred embodiment, the supported media types of the storage elements include a Compact Flash card, a Secure Digital card, a Memory Stick Pro card, a Multimedia card, a Smart Media card, an eXtreme Digital card, a Micro Drive and a Memory Stick card. The types of the memory cards recited above can be separated in two different divisions, one is the memory card with built-in MCU; another is the memory card without built-in MCU, and the preferred embodiment includes both types. The memory card without built-in MCU includes a Smart Media card, an eXtreme Digital card and a Memory Stick card. The memory card without built-in MCU need to build a physical to logical translation table (PLT table), in preferred embodiment the PTL table is built by the device driver.

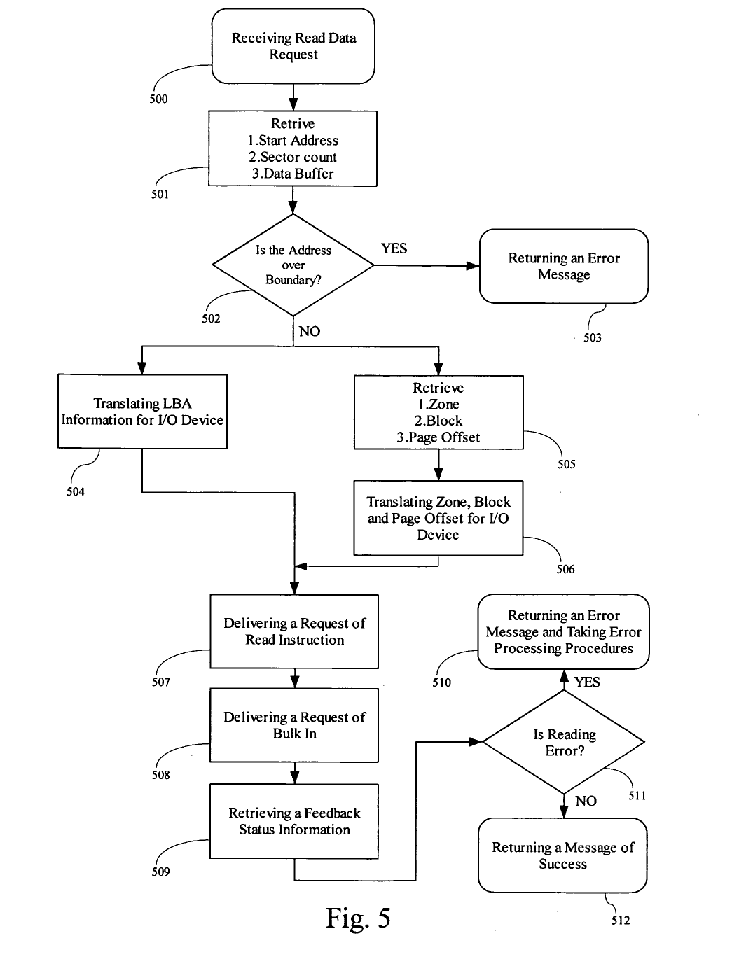

Referring to FIG. 5, which is a flow chart that illustrates process of reading data by executing the SCSI instruction Read Data 309. After the system receives a request for reading data 500, it will be performed to obtain the start address, sector count and data buffer of the storage element in step 501, and then verifies whether the address is over the boundary or not in step 502. When the address is out of the boundary, it returns an error message in 503. Otherwise, it continues to process the step 504 and 505 according to the type of the storage element. If the storage element is with built-in MCU, the step 504 is initiated to translate the logical block address (LBA) for I/O device 504. If the storage element is lack of built-in MCU, the step 505 and 506 will be executed to achieve the zone, block and page offset of the storage element in step 505, and then translates the zone, block and page offset for I/O device in the sequence of 506. The memory card without built-in MCU includes a Smart Media card, an eXtreme Digital card and a Memory Stick card, but not merely limits to these. When aforementioned process are finished, the device driver sends a request for reading data 507 and a request for bulk in 508. Both requests are contained in the IRP for delivering to the bus, and will be received by I/O device in later process. After the system receives the status information from I/O device 509, it verifies whether the status information is a reading error or not 511, and if there is a reading error, it returns an error message and starts the error processing procedure in 510. Otherwise, the device driver returns a success message in 512 to the system. Because there are no built-in MCU in the preferred embodiment, the PTL table is built by the device driver. So it is important to update the PTL table at the moment when the step of reading is finished, and it is also important to take the error processing procedures at the moment when the step of reading is finished and error is occurred.

The processing procedure of the SCSI instruction Write Data 310 is similar to the processing procedure of the Read Data 309. The difference is that the IRP sent by the device driver includes a request for writing data and a request for bulk out for Write Data 310.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. A method for driving I/O devices of a storage element, comprising:
sending an I/O (input/output) request by a user;
building hardware independent SCSI (small computer system interface) instructions based on said I/O request by a storage class driver;
executing said hardware independent SCSI instructions and transferring said hardware independent SCSI instructions into hardware dependent instructions by a storage port driver;
delivering said hardware dependent instructions by a bus driver to said I/O device of storage element; and
executing tasks according to said hardware dependent instructions by said I/O device of said storage element.

2. The method of claim 1, wherein said I/O device of storage element comprises an I/O device of storage element without built-in microprocessor control unit (MCU).

3. The method of claim 1, wherein said storage element comprises a memory card and a Micro Drive.

4. The method of claim 3, wherein said memory card comprises a memory card with built-in MCU and a memory card without built-in MCU.

5. The method of claim 4, wherein said memory card with built-in MCU comprises a Compact Flash card, a Secure Digital card, a Memory Stick Pro card or a Multimedia card.

6. The method of claim 4, wherein said memory card without built-in MCU comprises a Smart Media card, an eXtreme Digital card or a Memory Stick card.

7. The method of claim 4, wherein said storage port driver builds a physical to logical translation table (PLT table) of said memory card without built-in MCU.

8. The method of claim 1, wherein said I/O request is send by using a software application.

9. The method of claim 1, wherein said storage class driver comprises a disk class driver.

10. The method of claim 1, wherein said storage port driver comprises a device driver of said I/O device of said storage element.

11. The method of claim 1, wherein said hardware independent SCSI instructions are delivered in a form of an I/O request packet.

12. The method of claim 11, wherein data inside said I/O request packet which is delivered from said storage class driver to said storage port driver, comprise SCSI request blocks and command descriptor blocks.

13. The method of claim 11, wherein data inside said I/O request packet which is delivered from said storage port driver to said bus driver, comprise control data and bulk data.

14. The method of claim 13, wherein said control data are retrieved from compiling said SCSI instructions by said storage port driver.

15. The method of claim 1, wherein said bus driver comprises USB (universal serial bus) driver.

16. A method for driving a card reader, comprising:
sending an I/O request by a software application;
building an I/O request packet by a storage class driver according to said I/O request, wherein said I/O request packet further comprises SCSI request blocks and command descriptor blocks;
transferring said SCSI request blocks of said I/O request packet by a card reader driver into acceptable instruction formats of said card reader;
delivering said acceptable instruction formats of said card reader by a USB driver in a form of frame to said card reader; and
executing task according to data inside said frame by said card reader.

17. The method of claim 16, wherein said card reader comprises an I/O device of storage element without built-in MCU.

18. The method of claim 16, wherein said card reader uses for reading/writing a memory card and a Micro Drive.

19. The method of claim 17, wherein said memory card comprises a memory card with built-in MCU and a memory card without built-in MCU.

20. The method of claim 19, wherein said memory card with built-in MCU comprises a Compact Flash card, a Secure Digital card, a Memory Stick Pro card or a Multimedia card.

21. The method of claim 19, wherein said memory card without built-in MCU comprises a Smart Media card, an eXtreme Digital card or a Memory Stick card.

22. The method of claim 16, wherein said card reader driver builds a physical to logical translation table (PLT table) of said memory card without built-in MCU.

23. The method of claim 16, wherein said SCSI request blocks comprise hardware independent instructions, and wherein said acceptable instruction formats of said card reader comprise hardware dependent instructions.

24. The method of claim 16, wherein data inside said I/O request packet which is delivered from said card reader driver to said USB driver, comprise control data and bulk data.

25. The method of claim 24, wherein said control data are retrieved from compiling said SCSI request blocks by said card reader driver.
